(19) United States
(12) Patent Application Publication
(10) Pub. No.: US 2009/0252876 A1
(43) Pub. Date: Oct. 8, 2009

(54) SHEET FOR MOUNTING POLISHING WORKPIECE AND METHOD FOR MAKING THE SAME

(75) Inventors: Chung-Chih Feng, Kaohsiung (TW); I-Peng Yao, Kaohsiung (TW); Chen-Hsiang Chao, Kaohsiung (TW)

Correspondence Address: WPAT, PC;INTELLECTUAL PROPERTY ATTORNEYS, 2030 MAIN STREET, SUITE 1300, IRVINE, CA, 92614, US

(73) Assignee: SAN FANG CHEMICAL INDUSTRY CO., LTD., Kaohsiung (TW)

(21) Appl. No.: 12/482,330

(22) Filed: Jun. 10, 2009

Related U.S. Application Data
(63) Continuation-in-part of application No. 11/797,714, filed on May 7, 2007, now abandoned.

(51) Int. Cl. B05D 5/02

(52) U.S. Cl. 427/261; 427/385.5

(57) ABSTRACT

The present invention relates to a sheet for mounting a polishing workpiece. The sheet comprises a substrate and a surface layer. The substrate has a surface. The surface layer is located on the surface of the substrate, with no hole structure existing in the interior thereof, and has a surface and a slightly rough layer. The slightly rough layer is located on the surface of the surface layer to carry and mount the polishing workpiece, with no hole structure existing in the interior thereof. Accordingly, when the polishing workpiece contacts the slightly rough layer, the air therebetween is easily vented out via the slightly rough layer, without the phenomenon of air wrapping, which increases the adsorption force between the polishing workpiece and the sheet.

### CROSS-REFERENCE TO RELATED APPLICATIONS

This application is a continuation-in-part of copending application Ser. No. 11/797,714 filed May 7, 2007 claims the benefit thereof and incorporates the same by reference.

### BACKGROUND OF THE INVENTION

1. Field of the Invention

The present invention relates to a sheet for mounting a polishing workpiece and the method for making the same, and more particularly, to a sheet for mounting a polishing workpiece and the method for making the same which are used in the chemical mechanical polishing process.

2. Description of the Related Art

Polishing generally refers to a wear control for a preliminary coarse surface in the process of chemical mechanical polishing (CMP), which makes the slurry containing fine particles evenly dispersed on the upper surface of a polishing pad, and at the same time places a polishing workpiece against the polishing pad and then rubs the workpiece repeatedly with a regular motion. The polishing workpiece may be objects such as a semiconductor, a storage medium substrate, an integrated circuit, an LCD flat-panel glass, an optical glass and a photoelectric panel. During the polishing, a sheet must be used for carrying and mounting the polishing workpiece, and the quality of the sheet directly influences the polishing effect of the polishing workpiece.

Referring to FIG. 1, a schematic view of a polishing device with a conventional sheet disclosed in U.S. Pat. No. 5,871,393 is shown. The polishing device 1 comprises a lower base plate 11, a sheet 12, a polishing workpiece 13, an upper base plate 14, a polishing pad 15 and slurry 16. The sheet 12 is adhered to the lower base plate 11 through an adhesive layer 17 and is used for carrying and mounting the polishing workpiece 13. The polishing pad 15 is mounted on the upper base plate 14.

The operation mode of the polishing device 1 is as follows. First, the polishing workpiece 13 is mounted on the sheet 12, and then both the upper and lower base plates 14 and 11 are rotated and the upper base plate 14 is simultaneously moved downwards, such that the polishing pad 15 contacts the surface of the polishing workpiece 13. A polishing operation for the polishing workpiece 13 may be performed by continuously supplementing the slurry 16 and using the polishing pad 15.

Referring to FIG. 2, a local schematic view of the sheet of FIG. 1 is shown. The sheet 12 is of a single-layer structure, the material of which is generally PU (polyurethane), a kind of foaming material. The sheet 12 is formed by a wet process, and thus a plurality of continuous foaming holes 121 exists in the interior of the sheet 12. The disadvantage of the sheet 12 is that the slurry 16 tends to be inhaled through the foaming holes 121 during the polishing process, which causes changes in the hardness and physical property of the sheet 12, such that the polishing condition needs to be readjusted. Furthermore, the lifetime of the sheet 12 is reduced. In addition, the sheet 12 is formed by the wet process which results in an excessively low planarity, and it is very difficult to achieve a generally uniform thickness above 0.5 mm. Finally, the foaming holes 121 within the sheet 12 cause the phenomenon of air wrapping when the sheet 12 adsorbs the polishing workpiece 13, thus resulting in a poor adhesion and a possible crack during the polishing process as well as an uneven polished surface after the polishing of the polishing workpiece 13.

Consequently, there is an existing need for a sheet for mounting a polishing workpiece and the method for making the same to solve the above-mentioned problems.

### SUMMARY OF THE INVENTION

The objective of the present invention is to provide a sheet for mounting a polishing workpiece. The sheet of the present invention comprises a substrate and a surface layer. The substrate has a surface. The surface layer is located on the surface of the substrate, with no hole structure existing in the interior thereof, and has a surface ans a slightly rough layer. The slightly rough layer is located on the surface of the surface layer to carry and mount the polishing workpiece, with no hole structure existing in the interior thereof. Accordingly, when the polishing workpiece contacts the slightly rough layer, the air therebetween is easily vented out via the slightly rough layer, without the phenomenon of air wrapping, which increases the adsorption force between the polishing workpiece and the sheet, thereby improving the polishing effect of the polishing workpiece. Additionally, since no hole structure exists in the interior of both the surface layer and the slightly rough layer, the slurry will not be inhaled during the polishing, thus prolonging the lifetime of the sheet.

Another objective of the present invention is to provide a method for making the sheet for mounting a polishing workpiece, which comprises the following steps:

(a) forming a surface layer on a release paper, wherein the release paper has a pattern on a surface thereof, the material of the surface layer is thermosetting resin that has no hole structure in the interior thereof;

(b) forming a substrate on the surface layer;

(c) drying the surface layer and the substrate; and

(d) removing the release paper so as to form a slightly rough layer on the surface layer, wherein the pattern of the slightly rough layer corresponds to the pattern of the release paper, the slightly rough layer has a plurality of protrusions that are periodically repeated undulations, a vent space is formed between any two of the protrusions, and when the polishing workpiece contacts the slightly rough layer, the air therebetween is vented out via the vent space.

### BRIEF DESCRIPTION OF THE DRAWINGS

FIG. 1 shows a schematic view of the polishing device with a conventional sheet disclosed in U.S. Pat. No. 5,871,393;

FIG. 2 shows a local schematic view of the sheet of FIG. 1;

FIG. 3 shows a local schematic view of the sheet for mounting the polishing workpiece according to the present invention;

FIGS. 4 to 6 show schematic views of each process step of the method for making the sheet for mounting the polishing workpiece according to the present invention; and

FIG. 7 shows a partially enlarged schematic view of the sheet of FIG. 6.

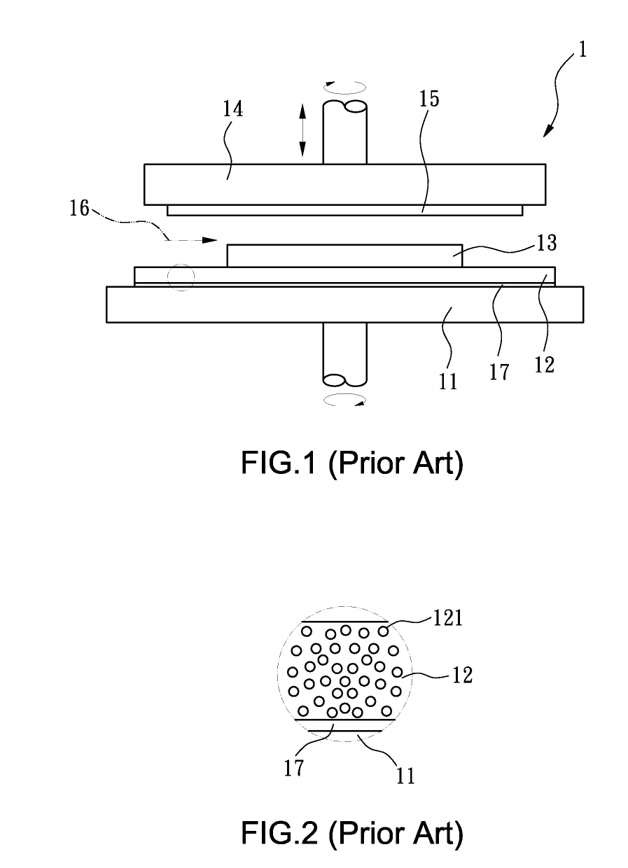

### DETAILED DESCRIPTION OF THE INVENTION

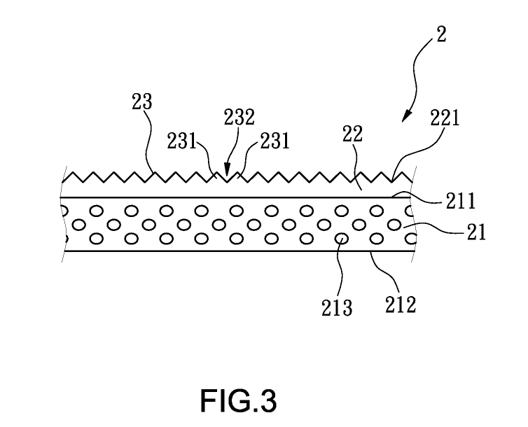

Referring to FIG. 3, a local schematic view of the sheet for mounting the polishing workpiece according to the present invention is shown. The sheet 2 of the present invention is of a two-layered structure, which comprises a substrate 21 and a surface layer 22. The substrate 21 has a first surface 211 and a second surface 212, wherein the second surface 212 is used for being adhered on the lower base plate (not shown) of a polishing device by a backside adhesive (not shown). In this embodiment, the material of the substrate 21 is high solid PU, with a plurality of continuous or discontinuous type holes 213 existing in the interior of the substrate 21, and the thickness of the substrate 21 can be larger than 0.5 mm. However, it is to be understood that the material of the substrate 21 may also be acrylic resin or another kind of resin.

The surface layer 22 is located on the first surface 211 of the substrate 21, and has a surface 221 and a slightly rough layer 23. The surface layer 22 has no hole structure in the interior thereof. The material of the surface layer 22 is a polymeric elastomer without foam (for example PU, acrylic resin or another kind of resin). The surface layer 22 has a uniform thickness which is less than that of the substrate 21. The materials of the surface layer 22 and substrate 21 may be the same or different.

The slightly rough layer 23 is located on the surface 221 of the surface layer 22, and is used for carrying and mounting a polishing workpiece (not shown). The slightly rough layer 23 is part of the surface layer 22, therefore, the materials of the slightly rough layer 23 and surface layer 22 are the same. A vent space 232 is formed between any two protrusions 231 of the slightly rough layer 23, and when the polishing workpiece contacts the slightly rough layer 23, the air therebetween may be easily vented out via the vent space 232, without the phenomenon of air wrapping, which increases the adsorption force between the polishing workpiece and the sheet 2, thereby improving the polishing effect of the polishing workpiece. Additionally, since no hole structure exists in the interior of both the surface layer 22 and the slightly rough layer 23, the slurry will not be inhaled during the polishing, thus prolonging the lifetime of the sheet 2.

The present invention further relates to a method for making the sheet for mounting a polishing workpiece, which comprises the following steps.

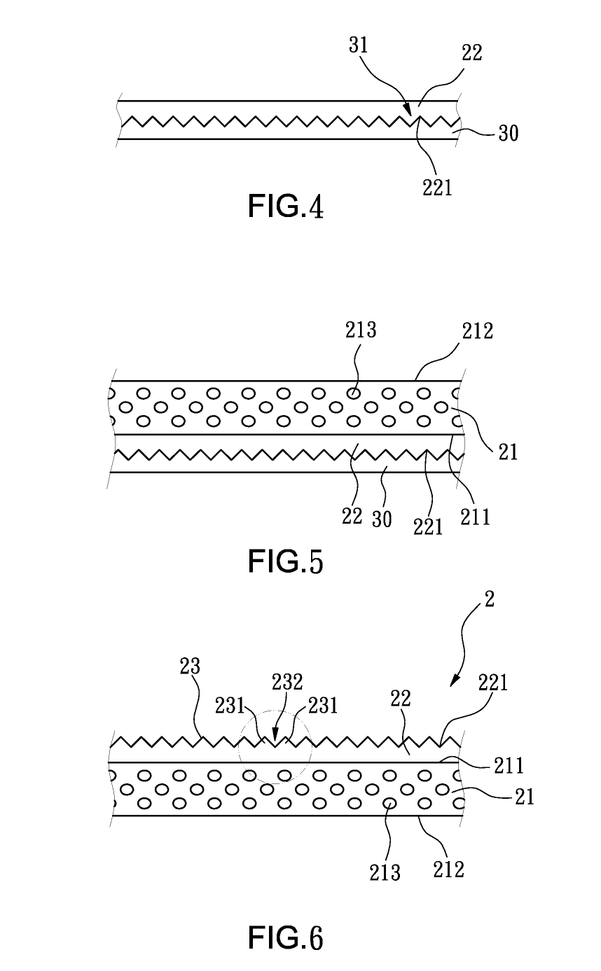

At first, referring to FIG. 4, a surface layer 22 is formed on a release paper 30. The release paper has a pattern 31 on a surface thereof. The surface layer 22 has no hole structure existing in the interior thereof. The surface layer 22 has a surface 221. The material of the surface layer 22 is thermosetting resin or a polymeric elastomer without foam (for example PU, acrylic resin or another kind of resin), and the surface layer 22 has a uniform thickness. Preferably, the surface layer 22 is formed on the release paper 30 in a manner of coating.

Then, referring to FIG. 5, a substrate 21 is formed on the surface layer 22, the substrate 21 has a first surface 211 and a second surface 212. In this embodiment, the material of the substrate 21 is high solid PU, with a plurality of continuous or discontinuous type holes 213 existing in the interior of the substrate 21, and the thickness of the substrate 21 is larger than 0.5 mm. The above-mentioned “continuous type holes 213” means that the holes communicate with each other, and fluid can flow in the holes. The above-mentioned “discontinuous type holes 213” means that the holes do not communicate with each other. However, it is to be understood that the material of the substrate 21 may also be acrylic resin or another kind of resin. The materials of the surface layer 22 and the substrate 21 may be the same or different. Preferably, the substrate 21 is formed on the surface layer 22 in a manner of coating. Therefore, compared with the conventional wet process, the substrate 21 of the invention can remain a uniform thickness when the thickness thereof is larger than 0.5 mm.

Then, the substrate 21 and surface layer 22 are dried for one day. After that, referring to FIG. 6, the release paper 30 is removed so as to form a slightly rough layer 23 on the surface 221 of the surface layer 22. The substrate 21 and the surface layer 22 are turned upside-down for 180 degrees to form the sheet 2 (the same as FIG. 3). The slightly rough layer 23 is part of the surface layer 22, therefore, the materials of the slightly rough layer 23 and surface layer 22 are the same. The pattern of the slightly rough layer 23 corresponds to the pattern 31 of the release paper 30. The slightly rough layer 23 has a plurality of protrusions 231, wherein the protrusions 231 are periodically repeated undulations. That is, the protrusions 231 are formed by particular manufacture process, and the protrusions 231 are not the asperities of the slightly rough layer 23.

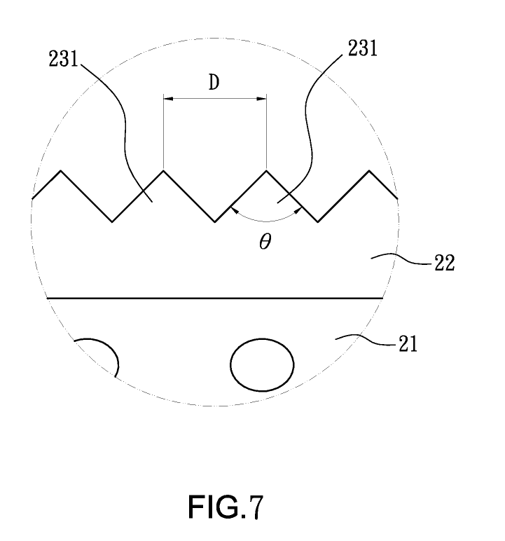

Referring to FIG. 7, in the invention, the slightly rough layer 23 is defined as follows: the Ra value is 0.5 to 15 μm (according to JIS B 0601-1994), the average interval D between the protrusions 231 is 0.5 to 10 μm (according to JIS B 0601-1994), and the average inclination angle θ of the protrusions 231 is 45 to 90 degrees.

Preferably, a water repellent treatment may also be performed for the slightly rough layer 23 to prolong the lifetime of the sheet 2.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. A method for making a sheet for mounting a polishing workpiece, comprising the following steps of:
(a) forming a surface layer on a release paper, wherein the release paper has a pattern on a surface thereof, the material of the surface layer is thermosetting resin that has no hole structure in the interior thereof;
(b) forming a substrate on the surface layer;
(c) drying the surface layer and the substrate; and
(d) removing the release paper so as to form a slightly rough layer on the surface layer, wherein the pattern of the slightly rough layer corresponds to the pattern of the release paper, the slightly rough layer has a plurality of protrusions that are periodically repeated undulations, a vent space is formed between any two of the protrusions, and when the polishing workpiece contacts the slightly rough layer, the air therebetween is vented out via the vent space.

2. The method as claimed in claim 1, wherein the substrate has a plurality of holes in the interior thereof.

3. The method as claimed in claim 2, wherein the holes of the substrate are of a continuous type.

4. The method as claimed in claim 2, wherein the holes of the substrate are of a discontinuous type.

5. The method as claimed in claim 1, wherein the surface layer is formed on the release paper in a manner of coating in the step (a).

6. The method as claimed in claim 1, wherein the substrate is formed on the surface layer in a manner of coating in the step (b).

7. The method as claimed in claim 1, wherein the Ra value of the slightly rough layer is 0.5 to 15 μm, the average interval between the protrusions is 0.5 to 10 μm, and the average inclination angle of the protrusions is 45 to 90 degrees.

8. The method as claimed in claim 1, further comprising a step of performing a water repellent treatment for the slightly rough layer.
